(19) United States
(12) Patent Application Publication
(10) Pub. No.: US 2003/0098132 A1
(43) Pub. Date: May 29, 2003

(54) Mechanical face seal for materials handling apparatus

(76) Inventor: Gary A. Mansdorfer, Louisville, CO (US)

Correspondence Address: John E. Reilly, 1554 Emerson Street, Denver, CO, 80218, US

(21) Appl. No.: 10/306,079

(22) Filed: Nov. 26, 2002

Related U.S. Application Data
(60) Provisional application No. 60/336,400, filed on Nov. 28, 2001.

(51) Int. Cl. B32B 31/00

(52) U.S. Cl. 156/556

(57) ABSTRACT

In materials handling apparatus, such as, a bottle labeling machine of the type having annular rotating and fixed members in confronting relation to one another, a facial seal assembly is made up of first and second seal members between the rotating and fixed members which are of generally rectangular cross-sectional configuration and terminate in squared end portions defining relatively broad, flat annular bearing surfaces in flush sealed relation to one another as the turntable is rotated or driven with respect to the stationary mounting portion and prevents ingress and egress of liquid as well as solid materials to and from the interior of the apparatus.

### CROSS REFERENCE TO RELATED APPLICATION

This application claims the benefit of Provisional Serial No. 60/336,400, filed 28 Nov. 2001, for MECHANICAL FACE SEAL FOR MATERIALS HANDLING APPARATUS by Gary A. Mansdorfer and owned by the assignee of the present application.

### BACKGROUND AND FIELD OF INVENTION

This invention relates to seals, and more particularly relates to a mechanical face seal of annular configuration primarily intended for use in conjunction with materials handling apparatus, such as, the rotary drive of a container labeling machine.

There are numerous applications where a system requires a seal between relatively rotating members or in which one member is rotating and the other one is fixed. For example, in labeling machines for bottles there is a need for a seal between annular rotor and stator members which will efficiently prevent oil or lubricant from leaking out of the system as well as to prevent liquid or solid contaminants from reaching the interior of the machine. Representative of such machines is the Krones Model No. 2-N19-47-705-1, manufactured and sold by Krones AG Hermann Kronseder Maschinenfabrik of Neutraubling, Germany, and incorporated by reference herein. A particular problem is the ability to maintain effective, uniform sealing between the annular rotor and stator parts in a contaminated environment and with minimal wear.

Conventional rotary shaft seal designs include lip seals intended to run on a very thin surface of lubricant film on a rotating shaft. The seals are typically effective for a short period of time and tend to wear very quickly by virtue of uneven wear and pressure between the contacting surfaces and which is partially attributable to contaminants passing between the contacting surfaces as well as the ingress and egress of water and lubricants.

It is therefore desirable in materials handling equipment, such as, bottle labeling machines to devise a facial seal assembly between the relatively rotating, annular stator and rotor members which will maintain uniform pressure and provide reduced wear while minimizing fluid leakage between the contacting, relatively rotating surfaces.

### SUMMARY OF THE INVENTION

It is therefore an object of this invention to provide for a novel and improved seal assembly for utilization in materials handling apparatus, such as, bottle labeling machines.

Another object of the present invention is to provide for a novel and improved annular facial seal between the rotor and stator members of materials handling apparatus which minimizes fluid leakage and maintains uniform sealing pressure between contacting surfaces.

It is a further object of the present invention to provide for a novel and improved seal assembly that has extremely good wear characteristics and is durable and efficient in use.

In accordance with the present invention, an annular seal assembly intended for use in materials handling apparatus of the type having a pair of annular, relatively rotating members disposed in confronting relation to one another and in outer spaced concentric relation to a rotary drive, the annular seal assembly comprising a first annular seal member mounted on one of the relatively rotating members, a second annular seal member mounted on another of the relatively rotating members, and each of the first and second annular seal members having a broad, flat annular bearing surface circumscribing each of the respective relatively rotating members, and the bearing surfaces being disposed in flush sealed relation to one another. The seal members are preferably of generally rectangular cross-sectional configuration have squared end portions which terminate in the bearing surfaces and at least the bearing surface for the first annular seal member is composed of a TEFLON® or TEFLON®-based material.

In its preferred application to a bottle labeling machine of the type having a rotary drive with a turntable provided with a downwardly depending outer peripheral skirt and a stationary mounting portion spaced beneath the skirt, the seal assembly comprises a first endless seal member including means mounting the first annular seal member in press-fit sealed engagement to the skirt, a second annular seal member including means mounting the second annular seal member in press-fit sealed engagement to the stationary mount, and the first and second annular seal members extending into confronting relation to one another and terminating in flat, annular low friction bearing surfaces disposed in flush, sealed relation to one another whereby to prevent liquid or solid contaminants from reaching the interior of the machine.

There has been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a fragmentary sectional view of a conventional rotary drive employed in association with a bottle labeling machine but incorporating the seal assembly of the present invention therein;

FIG. 2 is an enlarged, fragmentary sectional view of the improved seal assembly of the present invention; and

FIG. 3 is an enlarged, fragmentary sectional view of an alternate embodiment of the seal assembly of the present invention.

### DETAILED DESCRIPTION OF PREFERRED EMBODIMENT

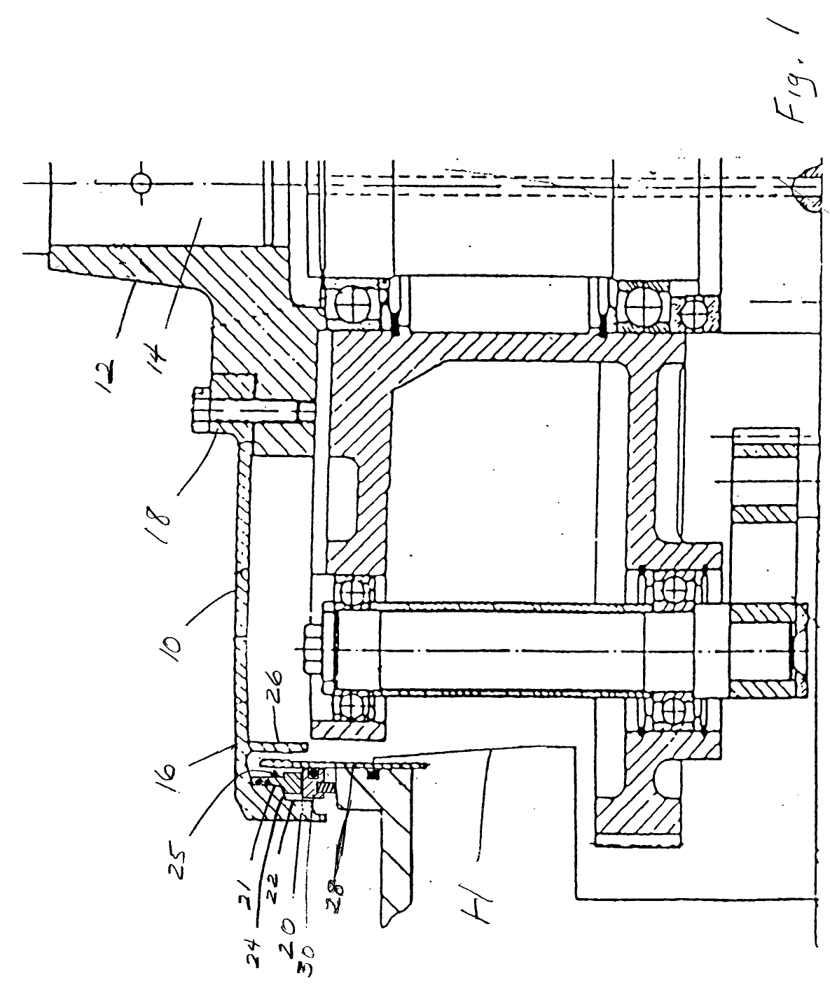

Referring to FIG. 1, there is shown by way of example a conventional rotary drive mechanism for a turntable or cover 10 of a labeling machine for bottles. The turntable is mounted on a hub 12 for rotation about a vertical axis through a main drive shaft 14 which is suitably driven by a motor, not shown. The turntable 10 has a generally circular cover 16 which is fastened as at 18 to the hub 12, and the cover 16 terminates in an outer downwardly projecting skirt 20 having inner stepped wall surfaces 21 and 22 interconnected by a shoulder or radial surface 24 for mounting of a preferred form of rotor which is defined by an upper face seal portion 25. The lid also includes a downwardly projecting flange 26 in spaced inner concentric relation to the skirt 20.

Further by way of illustrative example, the cover 16 forms the upper end of a housing generally designated at H for the various component parts of the drive mechanism for the labeling machine and which is at least partially filled with an oil bath, not shown. Typically, the bottles to be labeled are supplied to the outer periphery of the housing by means of an in feed starwheel which rotates next to the turntable and, as a part of the labeling process, the bottles are sprayed with water or other liquid in direct proximity to the turntable 10.

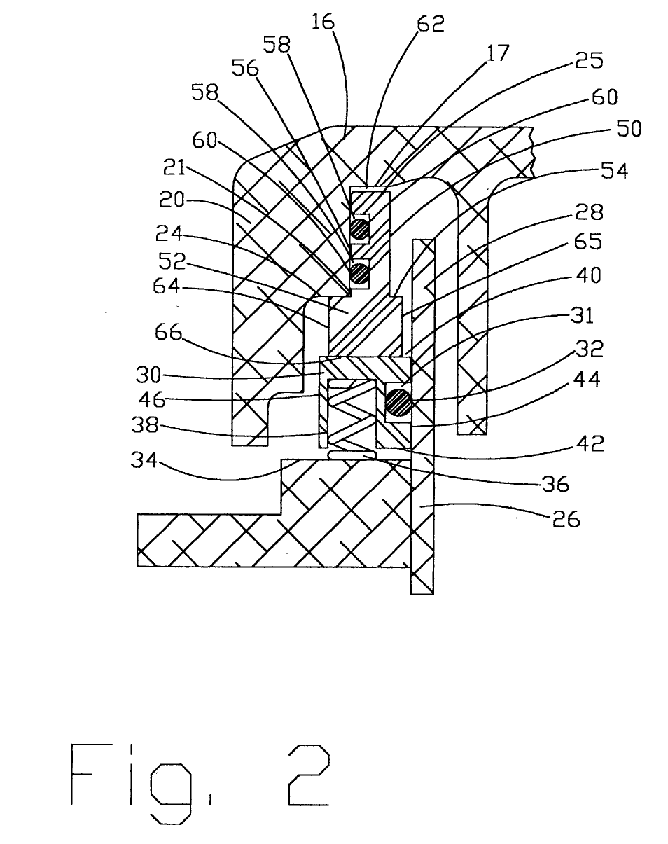

Referring to FIG. 2, interposed between the sp aced concentric skirt 20 and flange 26 is a vertically extending circular wall portion 28 of the housing H which serves as a stationary mount for an annular stator which is defined by a lower face seal portion 30. The stator or lower face seal portion 30 is of generally rectangular cross-section and provided with a groove 31 for an O-ring seal 32. The stationary mount includes a radially outwardly projecting support surface 34 vertically spaced beneath the stator 30, and the stator 30 is yieldingly positioned above the support surface 34 by means of a series of circumferentially spaced coil spring members 36, the spring members 36 being seated in downwardly directed bores 38 in the stator or lower face seal portion 30.

As previously described, the stator or lower face seal portion 30 is of generally rectangular cross-section having spaced, parallel horizontal top and bottom surfaces 40 and 42 and radially spaced, parallel vertical surfaces 44 and 46, respectively. The vertical surface 44 is mounted in snug-fitting relation to the housing portion 28, and the O-ring seal 32 forms a secondary seal between the stator 30 and housing 28.

The upper face seal portion 25 is in the form of an endless ring and is composed of a low friction material to be hereinafter described and defined by upper and lower unitized seal portions 50 and 52. The upper seal portion 50 is slightly longer in cross-section than the lower seal portion 52 but not as wide so as to fit snugly within and conform to the inner wall surfaces 21 and 24 of the skirt 20. Thus, the upper seal portion 52 is of generally rectangular cross-section and is dimensioned to be inserted snugly within the skirt 20 with a radially outer vertical surface portion 56 in close-fitting engagement with the inner wall surface 21 of the skirt 20; and a horizontal surface 54 of the lower seal portion bears against the under surface or ledge 24. Upper and lower spaced grooves 58, 58′ are formed in the upper seal portion in facing relation to the wall surface 21 of the skirt 20 for insertion of O-rings 60, 60′ to complete the sealed engagement with the inner wall surface 21. The upper seal portion is dimensioned such that the flat top surface 62 is in close proximity to the undersurface 17 of the lid 16, and the external shoulder surface 54 bears against the undersurface or ledge 24. In this way, the upper seal portion is effectively fixed for rotation with the lid 16.

The lower seal portion 52 depends downwardly from the upper seal portion and is also of generally rectangular cross-section having opposite parallel vertical surfaces 64 and 65 and a flat, broad horizontal bottom facial seal or bearing surface 66.

The stator or lower face seal portion 30 is yieldingly urged upwardly by the springs 36 such that the upper surface 40 bears firmly against the bottom surface 66 of the face portion 25, and there are a sufficient number of springs 36 mounted under compression to cause the stator or lower face seal portion 30 to maintain uniform sealed engagement with the bottom surface 66 as the face seal portion 25 is rotated due to fixed engagement with the rotating skirt 20. In this way, broad bearing surfaces are maintained between the face seal portion 25 and stator or lower face seal portion 30 to prevent liquid or solid contaminants from reaching the interior of the turntable housing and, for that matter, preventing the escape of oil from the interior of the housing.

The face seal portion 25 is preferably composed of a filled TEFLON® material, for example, a TEFLON® filled with FIBERGLAS® and moly disulfide but may be composed of other materials exhibiting low-friction characteristics, such as, polytetrafluoride (PTFE).

The notable advantage of establishing a broad seal surface 66 at the interface with the stator or lower face seal portion 30 is to maintain a uniform seal throughout the circumference of the stator or lower face seal portion 30 and wherein the seal has extremely good wear characteristics and minimizes the necessity of replacement. Further, it will be evident that the cross-sectional configuration of the seal may be modified to conform to different dimensions between relatively rotating parts in materials handling equipment. In labeling machines, the lid 16 may rotate at speeds on the order of 100 rpm and the seal 25, in following rotation of the lid 16, will bear firmly against the stator or lower face seal portion 30. The stator or lower face seal portion 30 may be composed of a hardened metal or silicon carbide or tungsten carbide material or any other hard material. Its upper surface 40 is flat and polished so as to provide a uniform interface to prevent leakage while presenting the least possible resistance to the rotational movement of the face seal portion 25. Further, it will be evident that the materials may be reversed so that the rotor 25 is composed of a hardened metal or one of the carbide materials as described, and the stator or lower face seal portion 30 is composed of a TEFLON® or other low friction material.

In practice, the press-fit mounting of the stator and rotor to the respective stationary mounting portion 28 and skirt 20 together with the urging of the spring members 36 enables close accurate adjustment between the rotor 25 and stator 30 for optimum sealing contact between the bearing surfaces 40 and 66 over their entire circumference. Thus, when the turntable 16 and skirt 20 are under rotation, the close-fitting engagement of the stator 30 to the mounting portion 28 is sufficient to fix it against rotation as the rotor bearing surface 66 slides across the bearing surface 40 of the stator 30. At the same time, the spring members 36 will exert a sufficient vertical force to maintain flush intimate contact between the bearing surfaces 40 and 66 throughout their respective peripheries. It will be evident that other mounting or fastening means may be employed between the seals 25 and 30 and their respective rotating and fixed annular parts of the machine, although the close-fitting engagement between the elements as described has been found to be particularly advantageous in maintaining flush engagement between the bearing surfaces 40 and 66. Moreover, while the preferred embodiment of the present invention employs broad flat bearing surfaces 40 and 66 it will be apparent that slightly curved or other complementary configurations can be utilized. Also, the bearing surfaces 40 and 66 may be inclined away from the horizontal as long as they are able to undergo shifting or slight radial displacement as the drive shaft is rotated.

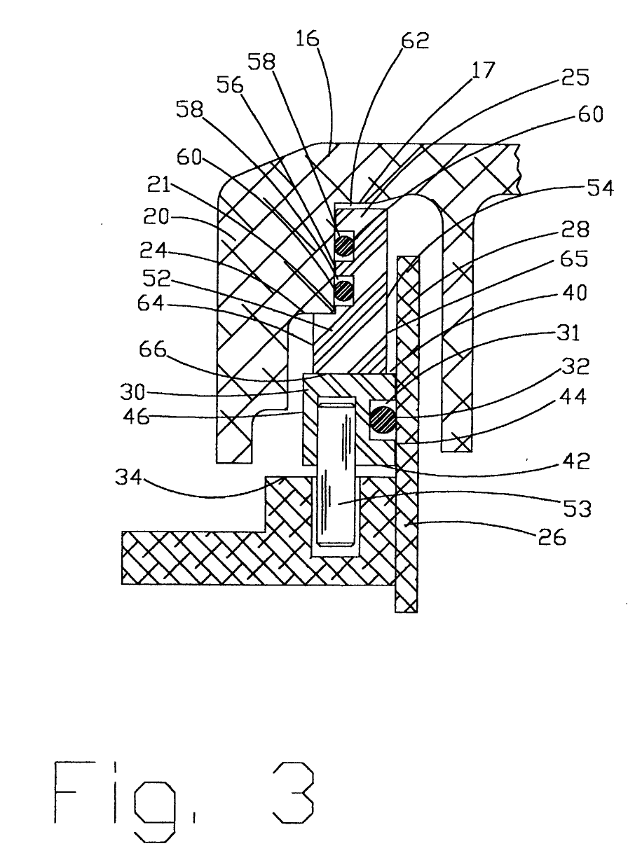

Referring to FIG. 3, there is shown an alternate embodiment of the seal assembly. An anti-rotation pin 53 is interposed between the support surface 34 and stator or stator 30 at a circumferentially spaced interval between a pair of spring members 36 to assure that the stator 30 remains in fixed relation to the mount 28. However, in practice, it has been found that the close-fitting engagement between the stator 30 and mount 28 is usually sufficient to maintain the stator or lower face seal portion 30 in substantially fixed relation to the mount 28 as well as to form a secondary seal between the O-ring 32 and the mount 28.

It is to be understood from the foregoing that while preferred and alternate forms of invention are herein set forth and described various modifications and changes may be made in the construction and arrangement of specific elements as well as its application to different relatively rotating members, such as, the rotor and stator as described without departing from the spirit and scope of the present invention as defined by the appended claims and reasonable equivalents thereof.

I claim:

1. In materials handling apparatus wherein a pair of annular, relatively rotating members are disposed in confronting relation to one another and in outer spaced concentric relation to a rotary drive, a facial seal assembly comprising:
a first annular seal member mounted on one of said relatively rotating members;
a second annular seal member mounted on another of said relatively rotating members; and
each of said seal members having a broad, flat annular bearing surface circumscribing each of said respective relatively rotating members, said bearing surfaces disposed in flush sealed relation to one another.

2. In apparatus according to claim 1 wherein one of said first and second seal members includes resilient biasing means for yieldingly urging said bearing surfaces into flush contacting relation to one another whereby to prevent the ingress and egress of liquid and solid contaminants to and from the interior of said apparatus.

3. In apparatus according to claim 1 wherein said seal members are of generally rectangular cross-sectional configuration having squared end portions defining said bearing surfaces.

4. In apparatus according to claim 1 wherein said first seal member has a unitized anchoring portion disposed in fixed relation to one of said relatively rotating members.

5. In apparatus according to claim 4 wherein said first seal member is in the form of an endless ring.

6. In apparatus according to claim 3 wherein said bearing surfaces for said first seal member is composed of a TEFLON®-based material.

7. In apparatus according to claim 3 wherein said first seal member includes an anchoring portion in press-fit relation to one of said relatively rotating members and said second seal member is fixed with respect to said first seal member.

8. In apparatus according to claim 2 wherein said resilient biasing means includes spring members disposed in circumferentially spaced relation to one another.

9. An annular seal assembly for mounting between an annular rotating member and an annular fixed member comprising:
a first annular mechanical facial seal member including a unitized anchoring portion for mounting said mechanical facial seal member in press-fit sealed engagement with said rotating member;
a second annular seal member mounted on said fixed member including resilient biasing means for urging a bearing surface on said second seal member into sealed engagement with a bearing surface on said mechanical facial seal member.

10. An annular seal assembly according to claim 9 wherein said mechanical facial seal member and said second seal member are each in the form of endless rings of generally rectangular cross-section having squared end portions defining said respective bearing surfaces.

11. An annular seal assembly according to claim 10 wherein said mechanical facial seal member is composed of a TEFLON® or TEFLON®-based material and said second seal member is composed of a hard, low friction material.

12. An annular seal assembly according to claim 9 wherein said annular rotating member includes a downwardly depending skirt and said unitized portion includes annular seal members in sealed engagement with said skirt.

13. An annular seal assembly according to claim 12 wherein said resilient biasing means includes a plurality of spring members in circumferentially spaced relation to one another between said fixed member and said second seal member.

14. An annular seal assembly according to claim 13 wherein an anti-rotating member extends between said fixed member and said second seal member.

15. In a bottle labeling machine of the type including a rotary drive having a turntable and downwardly depending outer peripheral skirt, and a fixed annular mount being vertically spaced beneath said skirt, the combination therewith of a seal assembly comprising:
a first endless seal member including means mounting said first annular seal member in press-fit sealed engagement with said skirt;
a second annular seal member including means mounting said second annular seal member in press-fit sealed engagement to said stationary mount; and
said first and second annular seal members extending into confronting relation to one another and terminating in flat, annular low friction bearing surfaces disposed in flush, sealed relation to one another wherein liquid or solid contaminants are prevented from reaching the interior of said machine.

16. In a bottle labeling machine according to claim 15 wherein said second annular seal member includes resilient biasing means for yieldingly urging said bearing surfaces into uniform sealed engagement with one another when said turntable is rotated with respect to said stationary mount.

17. In a bottle labeling machine according to claim 15 wherein said seal members are of generally rectangular cross-section having squared end portions terminating in said bearing surfaces.

18. In a bottle labeling machine according to claim 17 wherein said bearing surface for said first annular seal member is composed of TEFLON®, TEFLON®-based material or other low-friction material.

19. In a bottle labeling machine according to claim 16 wherein said resilient biasing means is defined by spring members circumferentially spaced between said stationary mount and said second annular seal member; and an anti-rotating pin disposed between said stationary mount and said second seal member.

20. In a bottle labeling machine according to claim 19 wherein said second annular seal member includes means mounting said second annular seal member in sealed relation to said stationary mount whereby said second annular seal member is fixed against rotation with respect to said stationary mount but is slidable in a direction toward said first annular seal member.
